(19) United States
(12) Patent Application Publication
(10) Pub. No.: US 2015/0327706 A1
(43) Pub. Date: Nov. 19, 2015

(54) DISPOSABLE PATIENT ROOM DIVIDER CURTAIN PROTECTIVE BARRIER FILM TO REDUCE INFECTION

(71) Applicants: Sally L. Harter, (US); Michael Fritsch, Indianapolis, IN (US)

(72) Inventors: Sally L. Harter, Carmel, IN (US); Michael Fritsch, Indianapolis, IN (US)

(21) Appl. No.: 14/653,007

(22) PCT Filed: Dec. 18, 2013
(86) PCT No.: PCT/US13/76032

§ 371 Date: Jun. 17, 2015

Related U.S. Application Data
(60) Provisional application No. 61/738,771, filed on Dec. 18, 2012.

(51) Int. Cl. A47H 23/02; E06B 9/24

(52) U.S. Cl. CPC A47H 23/02; E06B 9/24

(57) ABSTRACT

A protective barrier for use with a hospital or exam room divider curtain provides a physical and/or antimicrobial barrier for the curtain. Methods and devices for applying the protective barrier are provided.

### CROSS-REFERENCE TO RELATED APPLICATIONS

This application claims the benefit of U.S. Provisional Application No. 61/738,771 filed Dec. 18, 2012, the disclosures of which are hereby incorporated by reference in their entirety.

### FIELD

The present disclosure relates to the field of health care and prevention of infection. More particularly, the present disclosure relates to physical and antimicrobial barriers for a curtain.

### SUMMARY

The invention deals with keeping sterile the curtains between patients in a health care facility (i.e., double room, emergency room, out-patient exam room, school nurse clinic, etc.)

The invention is a device whereby a removable sterile appliqué or thin film is placed over the curtain edge where the curtain is customarily grasped to open and close it.

In one embodiment, a barrier for a curtain is provided. The barrier includes a first interior surface configured to be applied to a first side of the curtain, a first exterior surface opposite the first interior surface, a second interior surface configured to be applied to a second side the curtain opposite the first side of the curtain, and a second exterior surface opposite the second interior surface. In a more particular embodiment, at least one of the exterior surfaces may include an antimicrobial substance.

In one embodiment, a method for reducing contamination of infection sources of a curtain is provided. The method includes applying a barrier to an edge of the curtain, touching the barrier to position the curtain, and removing the barrier from the curtain.

In one embodiment, an applicator for applying a barrier to a curtain is provided. The applicator includes a handle, a first arm attached to the handle, and a second arm attached to the handle. The first arm is configured to apply a first film to a first side of the curtain while the second arm applies a second film to a second side of the curtain. In one more particular embodiment, the first arm comprises a first roller configured to receive the first film and the second arm comprises a second roller configured to receive the second film. In another more particular embodiment, the applicator also includes a cartridge containing a flowable material, a first conduit connecting the flowable material in the cartridge with a first plurality of openings in the first arm, and a second conduit connecting the flowable material in the cartridge with a second plurality of openings in the second arm. The flowable material is configured to flow through the first and second openings to coat a curtain positioned in an opening defined between the first and second arms.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 illustrates an exemplary applicator for applying a barrier according to the present disclosure;

FIG. 2 illustrates an exemplary curtain including an exemplary barrier;

FIG. 3 illustrates a user touching the barrier on the curtain of FIG. 2;

FIG. 4 illustrates applying a barrier to the curtain using the exemplary applicator of FIG. 1;

FIG. 5 is another view of applying the barrier as in FIG. 4;

FIG. 6 illustrates removing the barrier from the curtain;

FIG. 7A illustrates another exemplary barrier in a first, unapplied position;

FIG. 7B illustrates the exemplary barrier of FIG. 7A in a second, applied position;

FIG. 8 illustrates an exemplary barrier having a removable backing;

FIG. 9A illustrates an exemplary barrier having a receiver for a handle;

FIG. 9B illustrates the exemplary barrier of FIG. 9A with a handle positioned in the receiver;

FIG. 10A illustrates an exemplary barrier having a base for attaching a stick;

FIG. 10B illustrates the exemplary barrier of FIG. 9A with stick attached to the base;

FIG. 11A illustrates applying an exemplary barrier as a spray;

FIG. 11B illustrates a portion of the sprayed-onto barrier of FIG. 11A in a dried state;

FIG. 12A illustrates a partial cut-away view of another applicator for applying a barrier;

FIG. 12B illustrates the applicator of FIG. 12A applying a barrier to a curtain;

FIG. 12C illustrates the applicator and curtain of FIG. 12B following application of the barrier;

FIG. 13A illustrates an exemplary barrier including a semi-pliable gel;

FIG. 13B illustrates the exemplary barrier of FIG. 13A applied to a curtain;

FIG. 14A illustrates a roll of an exemplary barrier; and

FIG. 14B illustrates another exemplary applicator applying the barrier of FIG. 14A.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

In one exemplary embodiment, a barrier between a contaminated hand and a curtain material is provided. Since the hand or curtain may be contaminated by bacteria, virus, or other infectious source, transmission from patient to patient can occur by re-touching the curtain between patients and causing cross-contamination between successive patients. Since the device is a protective barrier film between the curtain and the hand, and is meant to be changed between patients, it will reduce contamination between successive patients. Thus, the barrier device is applied before the patient enters the room and is removed after the patient leaves the room. This same application and device removal is repeated for each patient.

In some embodiments, any curtain type can be easily covered by the barrier since the device barrier has an adhesive sticky coating on one side that will affix the device to the curtain. The adhesive is light enough that the barrier can be pulled away from the curtain between patients to change the barrier, but strong enough to affix the barrier to the curtain for the intended hospital/room stay or other desired time period.

In some exemplary embodiments, a “Y” shaped roller device is used to apply the film to the curtain. At the center of the “Y” is a hinge which allows the “Y” to close and touch both sides of the curtain. The “Y” shaped roller device is positioned around an end edge of the curtain and allows the film to be applied simultaneously to each side. Thus, each arm of the “Y” has a roll of barrier film connected as one strip of film by the two rolls. The “Y” shaped roller device is then closed around in the edge of the curtain and unrolled as it is dragged along the curtain edge. While the film is unrolled tightly against the curtain, it becomes adhered to the curtain. The area of curtain protected consisting of the height and length of the film is near the edge of the curtain, which is in the area maximally used by individuals using and moving the curtain; same with the depth of the film into the curtain.

In some exemplary embodiments, the barrier film is impregnated with one or more antimicrobial substances/molecules/atoms. Thus, in addition to a physical barrier a chemical barrier is achieved.

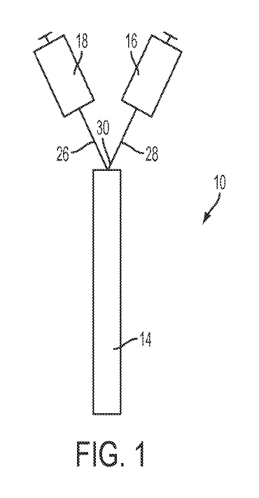

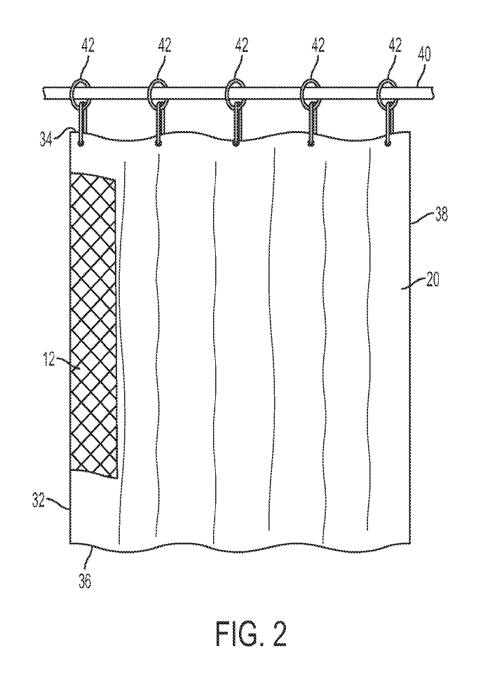

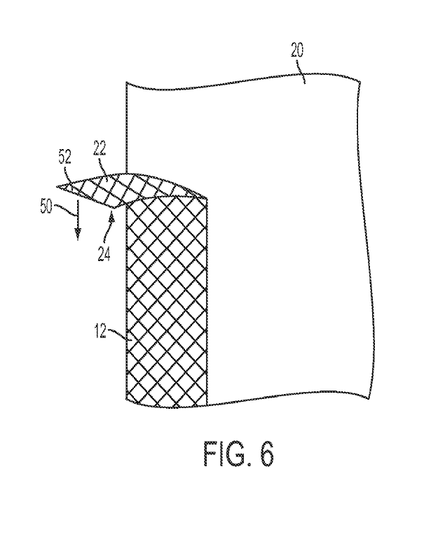

Referring first to FIG. 1, an exemplary applicator 10 for applying the barrier 12 (see FIG. 2) is provided. Applicator 10 includes a handle 14 allowing a user to hold and manipulate the applicator 10. As illustrated, applicator 10 further includes first roll 16 and second roll 18 of barrier 12 for application onto a curtain, such as curtain 20 (see FIG. 2). In one exemplary embodiment, first roll 16 and second roll 18 are separate rolls of barrier 12. In another exemplary embodiment (not shown), first roll 16 and second roll 18 are connected as one strip of barrier 12. Each roll 16, 18 of barrier 12 includes one or more barriers 12 for application to a curtain 20. In one exemplary embodiment, each barrier 12 has a first adhesive side 22 and a second outward-facing side 24 (see FIG. 6). When provided as roll 16, 18, adhesive side 22 of barrier 12 is provided on an outside surface of roll 16, 18, to allow adhesive side 22 to attach barrier 12 to curtain 20.

As illustrated in FIG. 1, applicator 10 may include Y-arms 26, 28 onto which rolls 16, 18 are provided. Rolls 16, 18 may include a passageway therethrough allowing rolls 16, 18 to rotate about Y-arms 26, 28. Y-arms 26, 28 are coupled by hinge 30. Hinge 30 allows Y-arms 26, 28 to open and close the applicator 10. In an open configuration, rolls 16, 18 are spaced apart and can be loaded or unloaded from applicator 10. In a closed configuration, rolls 16, 18 contact opposing sides of curtain 20 to apply the barrier 12 to curtain 20. In some configurations, hinge 30 includes a spring or other biasing element. Additionally, hinge 30 is actuated to move Y-arms 26, 28 (and therefore rolls 16, 18) toward one another by an actuator (not shown). As one of skill in the art will readily understand, actuator may be coupled mechanically to hinge 30 and/or arms 26, 28 in a number of different configurations, and be activated by a user through a button, lever, trigger or other mechanism.

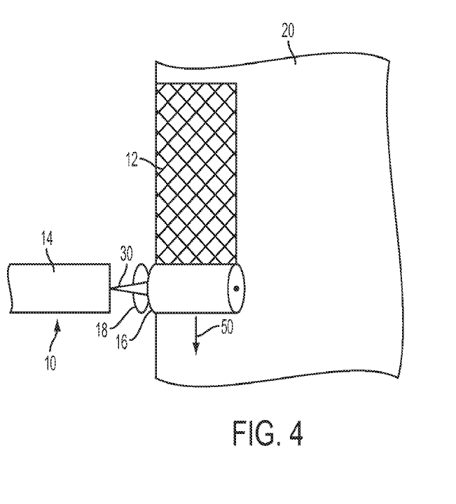

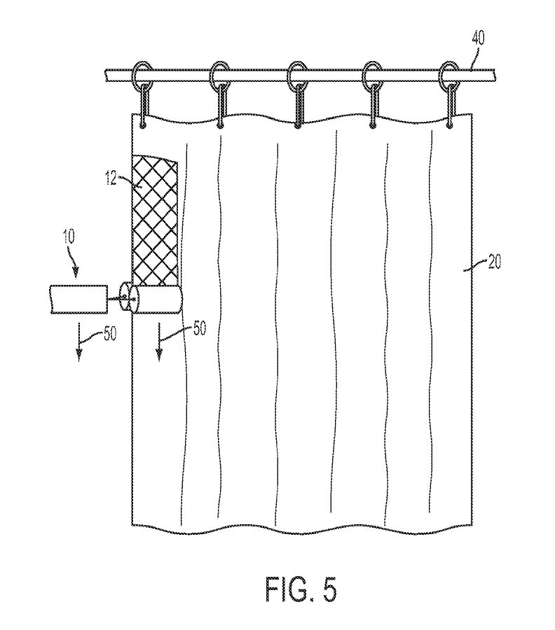

FIG. 2 illustrates an exemplary curtain 20 to which barrier 12 is applied. Barrier 12 may be applied to one or more sides of curtain 20. In the illustrated embodiment, barrier 12 is applied to opposing front and back sides of curtain 20 (see FIGS. 4 and 5).

In the illustrated embodiment, barrier 12 is applied to an edge 32 of curtain 20. In some embodiments, barrier 12 is applied along edge 32. In other embodiments, barrier 12 is applied spaced apart from edge 32. In still other embodiments, the barrier 12 is applied such that a portion of the film applied from roll 16 contacts a portion of the film applied from roll 18 thereby forming a seal along edge 32. In the illustrated embodiment, the barrier 12 covers only a central portion of edge 32 which is most likely to be grasped by personnel moving curtain 20. In other embodiments, the barrier 12 may extend along the entire length of edge 32 to a top edge 34, bottom edge 36, or both. In some embodiments, the barrier film is applied to multiple edges, such as to both edges 32 and 38.

As illustrated in FIG. 2, curtain 20 is illustratively hung from curtain rod 40 by a plurality of curtain hooks 42.

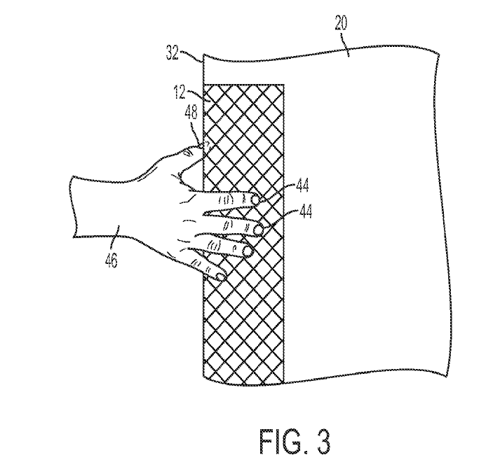

FIG. 3 illustrates a user contacting the barrier 12 on curtain 20. As illustrated, the user's fingers 44 and palm 46 contact a first barrier 12 on curtain 20, while the user's thumb 48 contacts a similar second barrier film (not shown) on the opposing side of curtain 20. In this way, the user is able to contact the curtain to move the curtain along curtain rod 40 (see FIG. 2), while touching only barrier 12 and not the surface of curtain 20.

In some exemplary embodiments, barrier 12 provides protection against contamination on a user's hand and/or a curtain material. One or both of the user's hand or curtain 20 may be contaminated by bacteria. Re-touching curtain 20 or touching multiple curtains 20 between patients may cause cross-contamination and increased potential for nosocomial infections resulting in secondary and/or tertiary superinfections. In some embodiments, barrier 12 provides a disposable surface that is periodically changed, such as between patients, after a high acuity event, or after a specific time period. This periodic change enables a reduction or elimination of such cross-contaminations. In some exemplary embodiments, barrier 12 is impregnated, coated, or otherwise contains an antimicrobial substance.

As used herein, antimicrobial refers to any substance that reduces, eliminates, or prevents one or more of bacteria, viruses, fungi, mycobacteria, or combinations thereof that can cause infection. Exemplary antimicrobial substances any film, molecule, chemical atom, nanotechnology, or other substance currently manufactured or in development that reduces, eliminates, or prevents microbes. In some non-limiting, exemplary embodiments, antimicrobial substance includes one or more of copper or silver. In some non-limiting, exemplary embodiments, the barrier 12 is an embedded-type film, including films with embedded metal nanoparticles, ions, molecules, chemicals, or other antimicrobial substances or a coated-type film, including films coated with metal nanoparticles, ions, molecules, chemicals, or other antimicrobial substances.

FIGS. 4 and 5 illustrate an exemplary method of applying barrier 12 to opposing sides of curtain 20 using the exemplary applicator 10 illustrated in FIG. 1. Applicator 10 is positioned such that first roll 16 and second roll 18 are on opposing sides of curtain 20, then moved to the closed configuration. The adhesive side of each barrier 12 on first roll 16 and second roll 18 contacts curtain 20. Applicator 10 is moved in direction 50, allowing first roll 16 and second roll 18 to rotate about Y-arms 26, 28. As first roll 16 and second roll 18 rotate, the barrier 12 unwinds from applicator 10 and is applied to curtain 20. When the desired length of barrier 12 is applied to curtain 20, applicator 10 is them moved to the open configuration. In one embodiment, first roll 16 and second roll 18 each contain a single barrier film. In another exemplary embodiment, first roll 16 and second roll 18 contain multiple lengths of barrier 12 that can be separated along a perforation or other separation during application on curtain 20. In still another exemplary embodiment, first roll 16 and second roll 18 contain a continuous barrier 12 that is pre-formed to provide the desired length of barrier 12 for curtain 20. In such an embodiment, the entire contents of rolls 16, 18 are applied to curtain 20 in each application. In yet still another exemplary embodiment, applicator 10 includes a cutting mechanism (not shown) to allow a user to apply a desired length of barrier 12 for curtain 20. Exemplary cutting mechanisms include, cutting blades, cutting teeth, scissors, and other suitable cutting mechanisms.

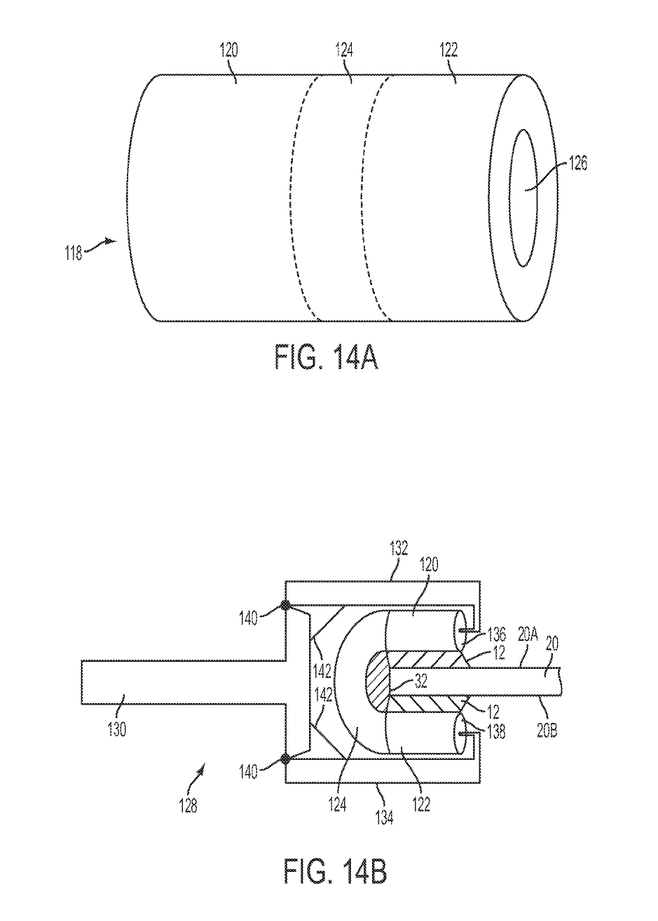

Referring next to FIG. 14A, an exemplary roll 118 of a barrier material is illustrated. Roll 118 includes a first portion 120 of barrier 12 and a second portion 122 of barrier 12 connected by a flexible central portion 124. Roll 118 illustratively has a central aperture to assist in the application of the roll 118 to a curtain, as shown in FIG. 14B. FIG. 14B illustrates an exemplary applicator 128 with handle 130. Applicator 128 includes a first arm 132 attached to a first roller 136 and a second arm 134 attached to a second roller 138. First and second roller 136, 138 are rotatably attached to first and second arms 132, 134, to allow application of roll 118 on to curtain 20. Roll 118 is positioned such that first roll 136 is received within aperture 126 of first portion 120 and second roll 138 is received within aperture 126 of second portion 122. The barrier 12 is applied from first portion 120 of roll 118 to first side 20A of curtain 20 and from second portion 122 of roll 118 to second side 20B of curtain 20. The flexible central portion 124 is wrapped over the edge 32 of curtain 20. First arm 132 and/or second arm 134 may be pivotally attached to handle 130 by one or more hinges 140. In another embodiment (not shown), first arm 132 is connected to second arm 134 by a single hinge 140. Hinges 140 allow first and second arms 132, 134 to move between an open configuration, allowing easier loading of roll 118, and a closed configuration, allowing application of roll 118 to a curtain 20. In some configurations, each hinge 140 includes a spring 142 or other biasing element.

FIG. 6 illustrates an exemplary method of removing the barrier 12 from curtain 20. In the illustrated embodiment, a corner 52 of barrier 12 is grasped and pulled downward in direction 50. The adhesive side 22 of barrier 12 releases from curtain 20, and the removed barrier 12 is disposed.

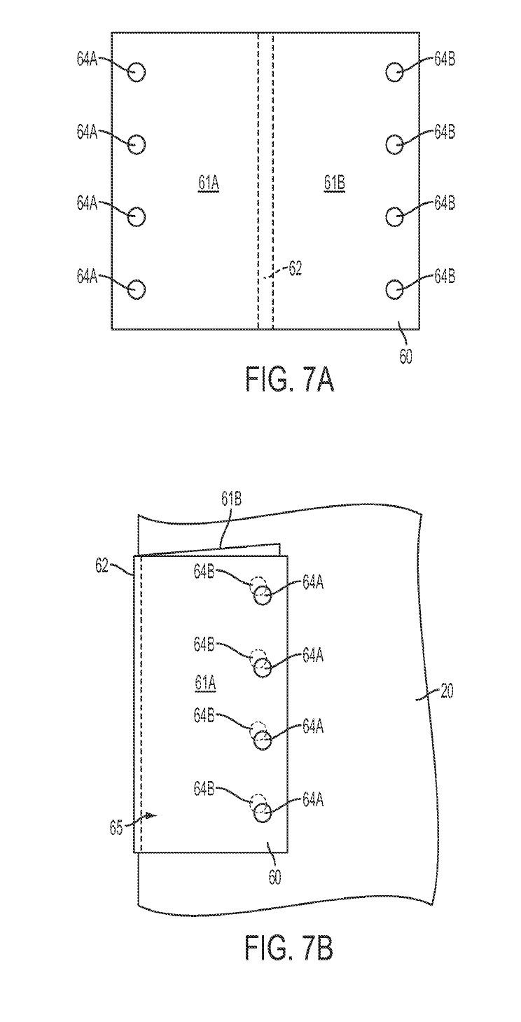

Referring next to FIGS. 7A-7B, another exemplary barrier 60 is illustrated. Exemplary barrier 60 includes a first portion 61A and a second portion 61B separated by central portion 62. Central portion 62 connects the interior and exterior of first portion 61A and second portion 61B as a continuous piece. In one embodiment, central portion 62 is flexible.

As shown in FIG. 7B, barrier 60 can be folded about central portion 62 with a curtain 20 positioned between first portion 61A and second portion 61B. As shown in FIG. 7B, when attached to curtain 20, an outward surface 65 faces away from curtain 20. In some embodiments, curtain 20 and/or outward surface 65 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above.

In one embodiment, barrier 60 is secured about curtain 20, as illustrated in FIG. 7B, by one or more attachment mechanisms 64. In one exemplary embodiment, barrier 60 includes a first plurality of attachment mechanisms 64A attached to first portion 61A and a second plurality of attachment mechanisms 64B attached to second portion 61B. In one exemplary embodiment, the first plurality of attachment mechanisms 64A and/or the second plurality of attachment mechanisms 64B attach or couple the barrier 60 directly to curtain 20. Illustrative attachment mechanisms for attaching or coupling the barrier 60 directly to curtain 20 include magnets, hook-and-loop fasteners such as Velcro, glue, paste, tape, snaps, buttons, and other suitable chemical and mechanical fasteners. In one exemplary embodiment, the first plurality of attachment mechanisms 64A attach or couple the barrier 60 to curtain 20 by coupling with the corresponding second plurality of attachment mechanisms 64B. Illustrative attachment mechanisms for attaching or coupling the barrier 60 in this manner include magnets and magnetically attractive elements, hook-and-loop fasteners such as Velcro, glue, paste, tape, snaps, buttons, biasing elements such as springs or hinges, and other suitable chemical and mechanical fasteners. In some embodiments, curtain 20 includes one or more apertures (not shown) to allow the first plurality of attachment mechanisms 64A to couple to the second plurality of attachment mechanisms 64B. In still another exemplary embodiment, the barrier 60 may be attached to curtain 20 by a friction fit.

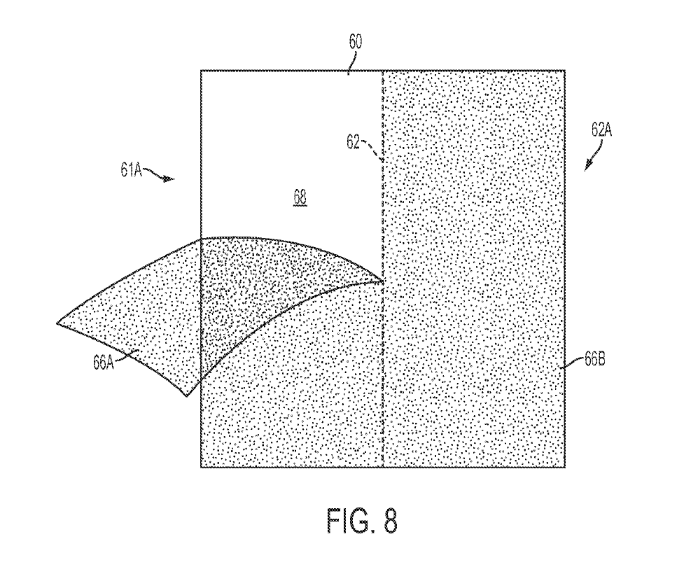

Referring next to FIG. 8, another exemplary embodiment of barrier 60 is illustrated. As shown in FIG. 8, barrier 60 may include an adhesive surface 68 opposite outward surface 65. Adhesive surface 68 may be covered by a removable backing 66. As illustrated in FIG. 8, removable backing 66 may comprising first removable backing 66A covering first portion 61A and second removable backing 66B covering second portion 61B. In another embodiment (not shown), a single removable backing covering both first portion 61A and second portion 61B is provided. Removing removable backing 66 exposes adhesive surface 68. In the exemplary embodiment illustrated in FIG. 8, barrier 60 includes a flexible central portion 62, about which barrier can be folded to apply adhesive surface 68 of first portion 61A and second portion 61B to curtain 20, as shown in FIG. 7B.

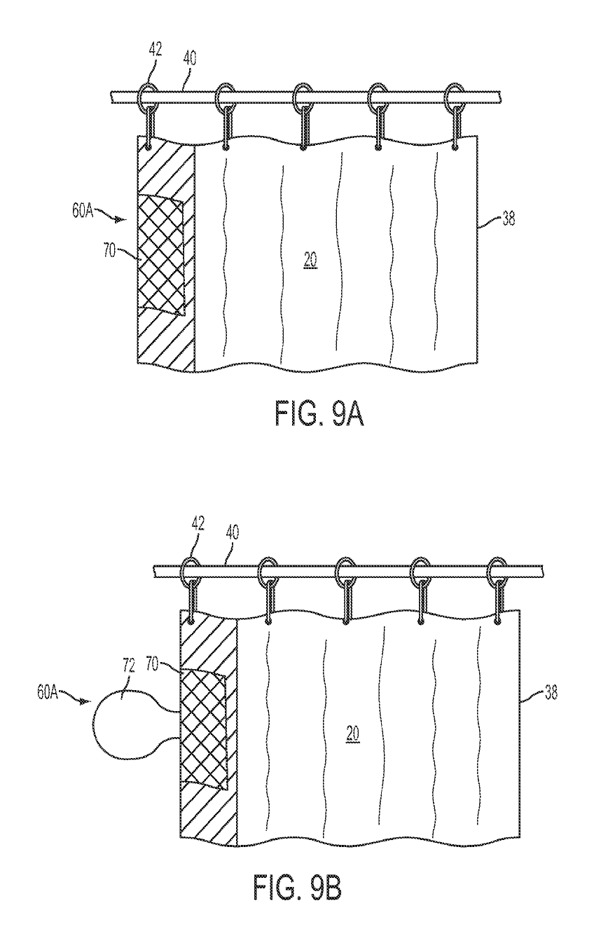

Referring next to FIGS. 9A and 9B, another exemplary embodiment of a barrier 60A is illustrated. In the exemplary embodiments illustrated in FIGS. 9A and 9B, barrier 60A includes a receiver 70 and a removable handle 72. As shown in FIG. 9A, curtain 20 is coupled to a receiver 70. Curtain 20 is attached to a curtain rod 40 through one or more curtain hooks 42 or other suitable hangers. In one embodiment, receiver 70 is integrally incorporated into curtain 20. In one embodiment, receiver 70 is attached to curtain 20 through a suitable chemical adhesive or mechanical fastener. As shown in FIG. 9B, a handle 72 is received within receiver 70.

In some embodiments, receiver 70, handle 72, and/or curtain 20 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, handle 72 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, a handle 72 is sterile and removably detachable from receiver 70. The handle 72 may be removed and replaced with a new handle 72 when the handle 72 becomes dirty or contaminated.

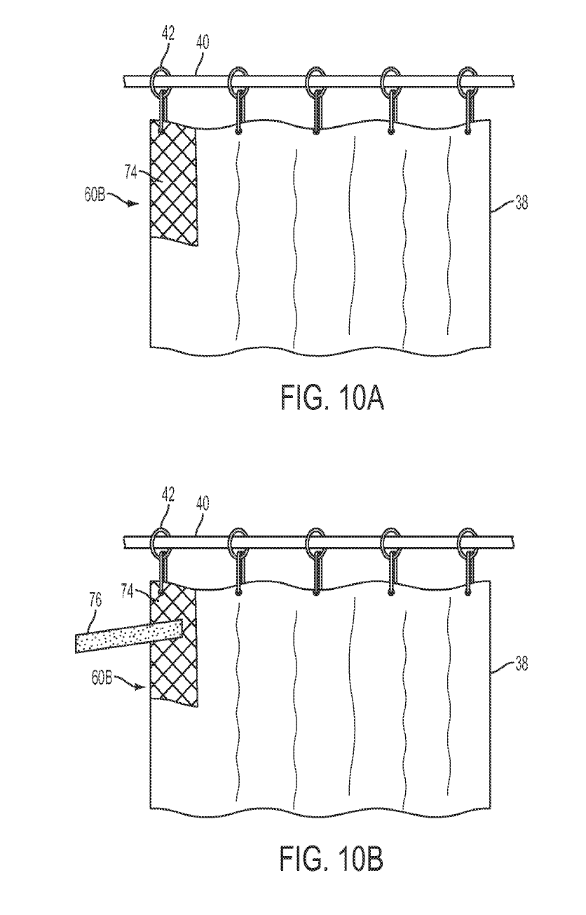

Referring next to FIGS. 10A and 10B, another exemplary embodiment of a barrier 60B is illustrated. In the exemplary embodiments illustrated in FIGS. 10A and 10B, barrier 60B includes a base 74 and a removable stick handle 76. As shown in FIG. 10A, curtain 20 is coupled to a base 74. Curtain 20 is attached to a curtain rod 40 through one or more curtain hooks 42 or other suitable hangers. In one embodiment, base 74 is integrally incorporated into curtain 20. In one embodiment, base 74 is attached to curtain 20 through a suitable chemical adhesive or mechanical fastener. As shown in FIG. 10B, a stick handle 76 is removably attached to the base 74 such that the stick handle 76 does not touch curtain 20. In the exemplary embodiment illustrated in FIG. 10B, the base 74 angles stick handle 76 away from the curtain 20 so that stick handle 76 can be grasped without touching the curtain 20.

In some embodiments, base 74, stick handle 76, and/or curtain 20 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, stick handle 76 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, a stick handle 76 is sterile and removably detachable from base 74. The stick handle 76 may be removed and replaced with a new stick handle 76 when the stick handle 76 becomes dirty or contaminated.

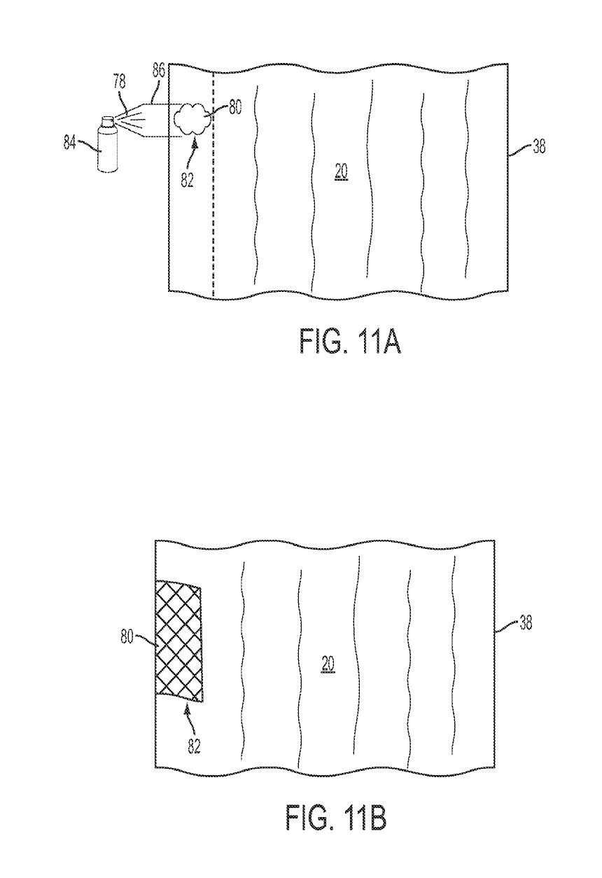

Referring next to FIGS. 11A and 11B, an exemplary embodiment of a spray-on barrier 80 is illustrated. In the exemplary embodiment illustrated in FIG. 11A, a sprayable material 78 is applied to a portion 82 of curtain 20 from applicator 84. Exemplary sprayable materials include, but are not limited to, sprays, mists, aerosols, foams, gels, and other suitable materials. Exemplary applicators 84 include, but are not limited to, spray cans, atomizers, nebulizers, aerosol cans, misters, and other suitable applicators.

In one embodiment, sprayable material 78 dries or cures to a final state to form spray-on barrier 80. Spray-on barrier 80 may have a final state that is dry, rigid, flexible, and/or of a gel-like consistency. Spray-on barrier contains an antimicrobial substance, chemicals, molecules, or atoms that causes a reduction in or an elimination of one or more bacteria, viruses, fungi, mycobacteria, or combinations thereof that can cause infection as described above.

As illustrated in FIG. 11A, in one exemplary embodiment, an attachment aiming hood 86 coupled to applicator 84 is used to confine the sprayable material 78 to portion 82 of curtain 20.

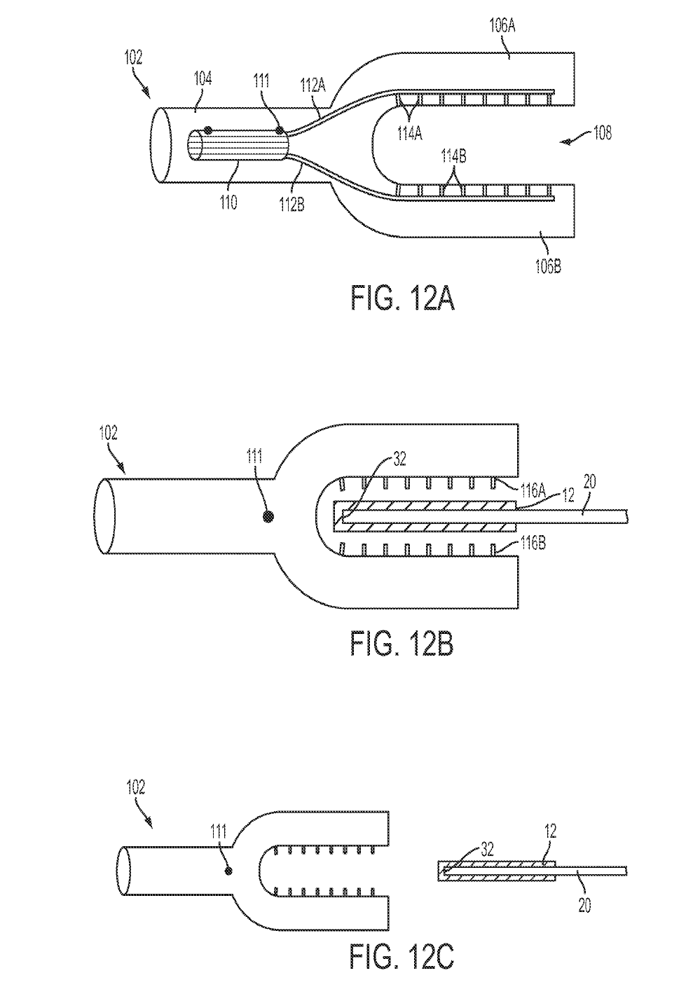

Referring next to FIGS. 12A-12C, another exemplary embodiment of an applicator 102 is illustrated. As illustrated in FIG. 12A, applicator 102 includes a handle 104 for gripping and manipulating applicator 102. Applicator 102 further includes first arm 106A and second arm 106B extending from handle 104. First arm 106A and second arm 106B define an opening 108 extending between first arm 106A and second arm 106B.

FIG. 12A further illustrates a cartridge 110 containing a material for forming a barrier 12 (see FIGS. 12B, 12C) on curtain 20. In one exemplary embodiment, the cartridge 110 contains a sprayable material similar to sprayable material 78 discussed above. In another embodiment, cartridge 110 contains a paste, gel, foam, or suitable extrudable material. Cartridge 110 illustratively includes a trigger 111 for releasing the material into first conduit 112A and second conduit 112B extending through an interior of applicator 102. First conduit 112A illustratively extends into first arm 106A and second conduit 112B illustratively extends into second arm 106B. First conduit 112A includes a first plurality of openings 114A and second conduit 112B includes a second plurality of openings 114B.

Referring next to FIG. 12B, an edge 32 of curtain 20 is positioned in opening 108. Trigger 111 is activated, causing the material to flow through first and second conduits 112A, 112B and through the first and second plurality of openings 114A, 114B. The first plurality of openings 114A illustratively directs a first plurality of material 116A towards a first side of curtain 20, while the second plurality of openings 114B illustratively directs a second plurality of material 116B towards a second side of curtain 20, forming barrier 12. In Edge 32 is illustratively covered by a portion of the barrier 12 from the first and/or second plurality of material 116A, 116B. In embodiments comprising a sprayable material, the first and second plurality of materials 116A, 116B are pressurized sprays of material directed towards curtain 20. In embodiments comprising a paste, gel, foam, or extrudable material, the first and second plurality of materials 116A, 116B are pressurized flows of material directed towards curtain 20.

Referring next to FIG. 12C, once the barrier 12 has been formed, trigger 111 is deactivated, ceasing the flow of sprayable material from cartridge 110. Applicator 102 is then removed from curtain 20, leaving behind the formed barrier 12. In some embodiments, the barrier may dry or cure to a final state after application.

In another embodiment (not shown), the applicator 102 includes a first roller rotatably coupled to the first arm 106A and a second roller rotatably coupled to the second arm 106B, the first openings 114A being configured to coat the first roller with the flowable material 116A prior to the flowable material 116A coating the curtain 20 and the second openings 114B being configured to coat the second roller with the flowable material 116B prior to the flowable material 116B coating the curtain 20.

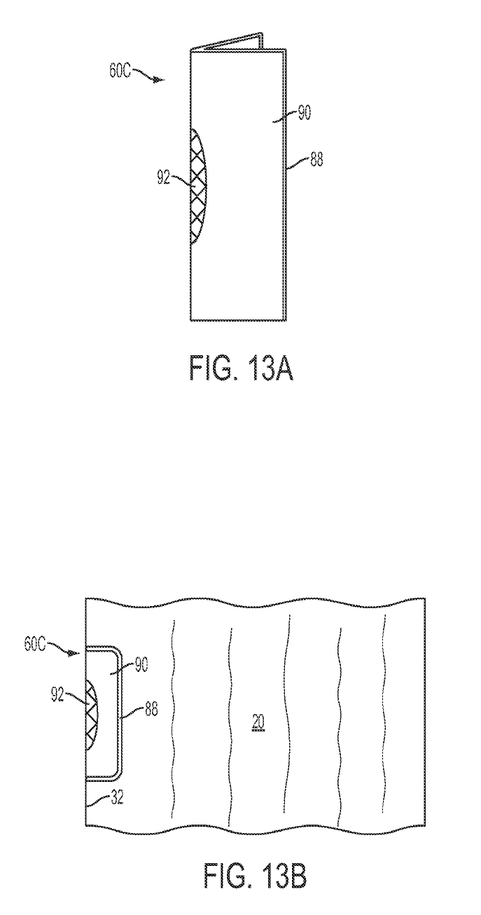

Referring next to FIGS. 13A and 13B, another exemplary barrier 60C is illustrated. In the exemplary embodiment illustrated in FIGS. 13A and 13B, barrier 60C includes an interior layer 88, an exterior layer 90, and a handle 92. In another embodiment (not illustrated), barrier 60C does not include a handle 92.

In one embodiment, interior layer 88 comprises a flexible material, such as a semi-pliable gel, that allows interior layer 88 of barrier 60C to form around an edge 32 of a curtain 20 (see FIG. 13B). In one embodiment, interior layer 88 includes an adhesive or tacky surface to adhere barrier 60C to curtain 20.

In one embodiment, exterior layer 90 is coupled to interior layer 88. In some embodiments, exterior layer 90 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, exterior layer 90 is formed from a flexible material, such as polycarbonate, that is removably coupled to the interior layer 88. In one embodiment, the exterior layer 90 may be peeled away from the interior layer 88 and replaced with a new exterior layer 90 when the exterior layer 90 becomes dirty or contaminated.

As illustrated in FIGS. 13A and 13B, barrier 60C optionally includes a handle 92. In some embodiments, handle 92 is impregnated, coated, or otherwise contains an antimicrobial substance, chemicals, molecules, or atoms that causes a reduction in or an elimination of one or more bacteria, viruses, fungi, mycobacteria, or combinations thereof that can cause infection as described above. In one embodiment, handle 92 is formed from a plastic or other polymeric material. In one embodiment, the handle 92 may be peeled away from the exterior layer 90 and replaced with a new handle 92 when the handle 92 becomes dirty or contaminated. In one embodiment, the handle 92 and exterior layer 90 may be peeled away from the interior layer 88 and replaced with a new handle 92 and exterior layer 90 when the handle 92 and/or exterior layer 90 becomes dirty or contaminated.

In one embodiment, barrier 60C covers only a portion of an edge 32 of curtain 20. In an exemplary embodiment, barrier 60C is about 16 to about 18 inches in height and about 12 inches in width.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within the known or customary practice in the art to which this disclosure pertains.

1. A barrier for a curtain comprising:
a film including a first interior surface configured to be removably coupled to a first side of the curtain;
a first exterior surface opposite the first interior surface; a second interior surface configured to be removably coupled to a second side of the curtain opposite the first side of the curtain; and
a second exterior surface opposite the second interior surface.

2. The barrier of claim 1, wherein the first exterior surface includes an antimicrobial substance.

3. (canceled)

4. The barrier of claim 2, wherein the antimicrobial substance comprises at least one of copper and silver.

5. (canceled)

6. The barrier of claim 1, wherein the second interior surface comprises an adhesive configured to removably couple the barrier to the curtain.

7. The barrier of claim 1, wherein the barrier is a film configured to be removed from the curtain and disposed after use.

8. The barrier of claim 1, further comprising a flexible central portion, the flexible central portion connecting the first and second interior surfaces and the first and second exterior surfaces, the flexible central portion being configured to cover an edge of the curtain.

9. The barrier of claim 8, further comprising one or more attachment mechanisms configured to attach the barrier to the curtain, the mechanisms selected from the group consisting of magnets, hook-and-loop fasteners, glue, paste, tape, snaps, buttons, and chemical adhesives.

10. The barrier of claim 1, further comprising at least one removable backing, wherein the removable backing is positioned adjacent the first interior surface and configured to be removed from the first interior surface prior to applying the barrier to the curtain.

11. The barrier of claim 1, further comprising a handle configured to be removably coupled to the barrier.

12. The barrier of claim 11, wherein the handle is sterile.

13. The barrier of claim 11, wherein the first exterior surface includes a receiver, the handle being configured to be removably coupled to the receiver.

14. The barrier of claim 11, wherein the curtain includes a receiver integral with the curtain, the handle being configured to be removably coupled to the receiver.

15. The barrier of claim 11, wherein the handle is a stick handle coupled to a receiver coupled to the curtain, wherein the stick handle is spaced apart from the curtain and extending in a first direction away from an edge of the curtain.

16-17. (canceled)

18. A method for reducing contamination by infection sources of a curtain comprising:
applying a barrier to an edge of the curtain;
touching the barrier to position the curtain;
removing the barrier from the curtain.

19. The method of claim 18, wherein the barrier has a first surface adhering the barrier to the curtain and a second surface opposite the first surface, wherein touching the barrier includes touching the second surface.

20. The method of claim 19, wherein the second surface includes an antimicrobial substance.

21. The method of claim 18, further comprising applying a second barrier to the edge of the curtain after the first barrier is removed.

22. The method of claim 18, wherein applying the barrier comprises simultaneously applying a first portion of the barrier to a first side of the curtain and a second portion of the barrier to a second side of the curtain opposite the first side.

23-30. (canceled)

31. The barrier of claim 4, wherein the antimicrobial substance comprises copper.

32. The barrier of claim 1, wherein the barrier further comprises:
an interior layer including the first interior surface and an adhesive or tacky surface configured to adhere the barrier to the curtain; and
an exterior layer including the first exterior surface, wherein the exterior layer is configured to be peeled away from the interior layer when the exterior layer becomes dirty or contaminated.
